(19) United States
(12) Patent Application Publication
(10) Pub. No.: US 2011/0308664 A1
(43) Pub. Date: Dec. 22, 2011

(54) Boat water supply winterization system and method

(76) Inventor: John Gregal, Arlington, VA (US)

(21) Appl. No.: 13/162,545

(22) Filed: Jun. 16, 2011

Related U.S. Application Data
(60) Provisional application No. 61/397,639, filed on Jun. 16, 2010.

(51) Int. Cl. B65B 3/04; B08B 3/00

(52) U.S. Cl. 141/1; 137/15.04; 141/59

(57) ABSTRACT

A method for winterizing boat engines and a system with components designed for performing the method comprising an air-pressure-supply means that can be used to pressurize the system and thereby force water out the inlet port, an anti-freeze supply means that will supply anti-freeze liquid into the system when the component that is to be winterized is operated to draw water, and means for coupling these components to the water system.

This application claims priority from U.S. Provisional application 61/397,639 filed Jun. 16, 2010.

### BACKGROUND

Boats with inboard motors that are kept in cold climates over the winter and allowed to fall in temperature to below freezing must be “winterized” by flushing out water from seawater intake systems and, usually, replacing the seawater with anti-freeze solution to prevent sea water from re-entering the system. In warmer climates, boats may be “winterized” when they will not be used for a season. This operation typically requires two people, one to operate the pump and another to provide the anti-freeze solution to the right spot at the right time at the right rate.

### SUMMARY OF THE INVENTION

This invention addresses two objectives: (1) to flush sea water out, and (2) to supply anti-freeze in a suitable quantity, location, and rate.

In one aspect, the invention is a method for flushing water out of a sea water supply system in a boat, the method involving having in a boat a sea water supply system with an inlet port, an inlet port valve, a water intake hose, a component that requires sea water with a normally closed opening, and an exit port. The steps of the method are: (a) close the inlet port valve; (b) open the opening and couple to the opening an air pressure supply means which applies air pressure to the system; (c) open the inlet port valve and leaving it open until air pressure has forced water out the inlet port and air has begun to escape out the inlet port; and (d) close the inlet port valve.

The component that requires sea water with a normally closed opening may be a water strainer. The opening may be a lid on top of the strainer.

The air pressure supply means may be a tube adapted for coupling a vacuum cleaner hose to the opening or coupling a compressed air supply source, such as a bottle of compressed gas to the opening. The gas may be compressed from the earth's atmosphere and therefore comprise a mixture of gasses typical of air, or it may be predominantly a single gas.

In another aspect, the invention is a method for supplying anti-freeze into a sea water supply system in a boat having a sea water supply system with an inlet port, an inlet port valve, a water intake hose, a strainer having a normally closed opening, a component that requires sea water, and an exit port. The method consists of the steps of (a) opening the strainer opening and coupling to the opening an anti-freeze supply means which supplies anti-freeze as needed for winterization of the system; (b) operating the component that requires sea water to draw anti-freeze into the component, (c) uncoupling from the opening the anti-freeze supply means, and (d) closing the opening.

The opening may be one that supports a lid on top of the strainer. The anti-freeze supply means may be a reservoir sitting on the strainer. The reservoir may have a conical open bottom portion that couples to the strainer opening by protruding into the strainer opening. The reservoir may have an upper opening for receiving anti-freeze that is wider than the conical open bottom portion. The reservoir may be coupled to a spring, such as a bungee cord, that, when installed on the strainer, urges the conical open bottom portion into contact with the strainer.

In another aspect, the invention is a system with components designed for performing the above methods comprising an air-pressure-supply means that can be used to pressurize the system and thereby force water out the inlet port, an anti-freeze supply means that will supply anti-freeze liquid into the system when the component that is to be winterized is operated to draw water, and means for coupling these components to the water system.

The air pressure supply means may be a tube for use with a source of low-pressure gas, such as the outlet of a vacuum cleaner, or a tube for coupling to an air compressor or bottle of compressed gas. The anti-freeze supply means may be a reservoir such as a funnel large enough to hold needed anti-freeze. A spring such as a bungee cord may be used to couple the funnel to an opening of the water system. Threads in the funnel and in the pressurized gas supply tube may allow them to be coupled together.

### BRIEF DESCRIPTION OF THE FIGURE

FIG. 1 shows the components of two alternative embodiments of the invention.

### DETAILED DESCRIPTION

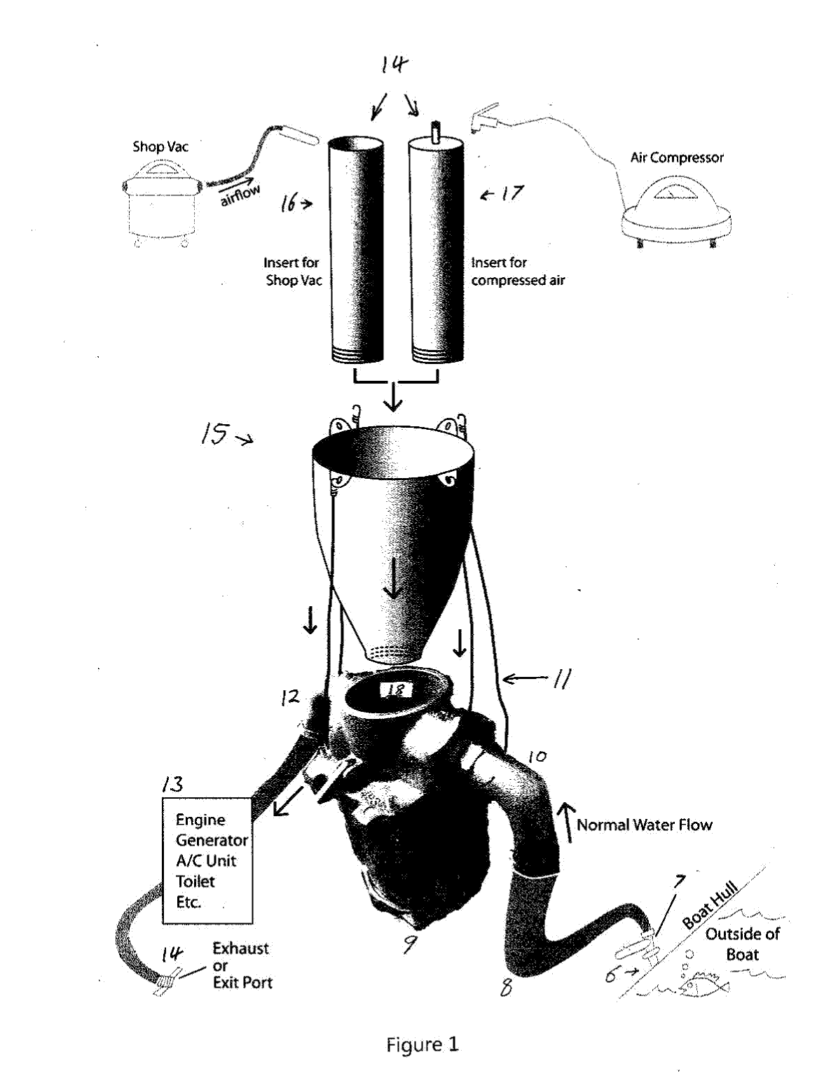

For purposes of this document, a typical water supply system in a boat comprises, as shown in FIG. 1, an inlet port 6, an inlet port valve 7, a water intake hose 8, a water strainer 9, which has a strainer inlet 10, a strainer opening 18, a strainer outlet 12, a component that requires sea water 13, and an exit port 14. The component that requires sea water might be an engine, a generator, an air-cooling unit, a toilet, or any other component.

The strainer 9 is typically installed at a high point in the system with an opening 18 at the highest point. The allows the strainer lid (not shown) to be opened for cleaning while valves are closed without spilling water into the boat. The invented system and method can be employed in a water system without a strainer provided there is a relatively high point where the system can be opened with a large enough hole that can be coupled to.

The invented system is coupled into the water system, preferably at a relative high point, preferably at the top of the strainer 9 to assist first with flushing sea water out of the system and then supplying anti-freeze solution into the system. It is typically preferable to flush sea water out the component 13 and replace the sea water with anti-freeze.

To accomplish these purposes, the invented system components comprise: an air-pressure-supply means 14 that can be used to pressurize the system and thereby force water out the inlet port, an anti-freeze supply means 15 that will supply anti-freeze liquid into the system when the component 13 is operated to draw water, and coupling means, such as a bungee 11, for coupling these components to the water system opening 18.

The air pressure supply means 14 may be a tube for use with a source of low-pressure gas 16, such as the outlet of a vacuum cleaner, or a tube for coupling to an air compressor or bottle of compressed gas 17. The anti-freeze supply means may be a reservoir such as a funnel 15 large enough to hold all the needed anti-freeze. A spring such as a bungee cord 11 may be used to couple the funnel to an opening 18 of the water system. Threads in the funnel 15 and in the pressurized gas supply tube 14 may allow them to be coupled together.

In preferred embodiments, the funnel 15 is tapered to fit various size sea strainer lid openings 18. The outer surface of the tapered portion of the funnel is coated with a rubber-type material to create a water and air tight seal between the funnel and the opening of the sea strainer.

Bungee cords 11 hook to the funnel and wrap around the inlet 10 and outlet 12 fittings on the sea strainer. This pulls the funnel down into the sea strainer's opening 18 to secure the funnel 15 in place and help create the water and air tight seal between the funnel and the opening of the sea strainer.

The invented system includes two different threaded inserts 14 to accommodate pressurized air. One insert 16 receives compressed air from a shop vacuum (wet-dry vac). The insert for the shop vacuum is hollow and tapered to accept various size shop vac hoses. The alternative insert receives air from an air compressor or bottle of compressed gas. The funnel 15 has threads to accept threads on the inserts 14.

### Method of Using the Invented System Components

1. Close the water intake valve to prevent water from entering the boat once the sea strainer (aka raw water filter) lid is removed.

2. Open the sea strainer lid and remove the strainer basket.

3. Place the funnel device down into sea strainer's opening and secure with bungee hooks looping around the filter's inlet and outlet fittings. The rubberized outer skin of the funnel will create a relatively water tight seal between the funnel and the sea strainer's opening.

3A (only necessary for boats that are stored in the water, not stored on land). Screw the appropriate insert (shop vacuum or air compressor) down into the funnel. Blow compressed air down into the strainer and open the water intake valve. Listen/look for bubbles outside the boat. Close valve and stop the compressed air. The water hose up to the sea strainer is now purged of water and thus cannot freeze. (Step 3A can also be performed to clear any debris (seaweed/trash) that may have been drawn up through the boat's through hull fitting, restricting the flow of water. This is another use for the funnel device.)

4.Remove the insert, if used, and prepare several gallons of biodegradable antifreeze to be poured into the funnel. Briefly start the component that is being fed raw water by the sea strainer (e.g. engine, generator, air conditioning unit, or toilet). Immediately pour antifreeze into the funnel until equally colored antifreeze (not diluted by the water in the system) can be seen exiting the boat through the device's exhaust/exit port. Immediately turn off the component so that the raw water pump is not run dry by pumping out the antifreeze. Antifreeze will also flow back and fill the water inlet hose that was purged in step 3A, further assuring it is winterized. The raw water system fed by that sea strainer is now purged of sea water and replaced with antifreeze.

4A. In warmer climates, if the funnel is being used to flush salt water from the system, fresh water can be substituted for antifreeze. Be sure there is sufficient water to keep up with the normal amount of flow for the pump of the engine/generator/Air Conditioning unit/toilet.

5. Remove the funnel from the sea strainer. Replace the strainer basket and secure the strainer's lid.

The winterization/flush process is now complete. To de-winterize, open raw water valve and start the engine/generator/air conditioner/toilet and visually verify the flow of sea water through the sea strainer. The antifreeze left in the bottom of the sea strainer will be replaced with raw water.

Note: For the rare applications where engines/generators are fed cooling water through sea strainers and do not have closed cooling systems, the funnel device can be used to winterize the raw water hoses, sea strainer and exhaust system, but the engine itself will need to be drained of sea water to assure full freeze protection. This is because the engine's thermostat dictates the flow of cooling water (or antifreeze during step 4) through the engine and one cannot be assured of full winterization without knowing that antifreeze was allowed into the engine by the thermostat during step 4.

1. A method for flushing water out of a sea water supply system in a boat, comprising:
a. having in a boat a sea water supply system comprising an inlet port, an inlet port valve, a water intake hose, a component that requires sea water with a normally closed opening, and an exit port;
b. closing the inlet port valve;
c. opening the opening and coupling to the opening an air pressure supply means which applies air pressure to the system;
d. opening the inlet port valve and leaving it open until air pressure has forced water out the inlet port and air has begun to escape out the inlet port; and
e. closing the inlet port valve.

2. The method of claim 1 where the component is a water strainer.

3. The method of claim 2 where the opening is a lid on top of the strainer.

4. The method of claim 1 where the air pressure supply means is a tube adapted for coupling a vacuum cleaner hose to the opening.

5. The method of claim 1 where the air pressure supply means is a tube adapted for coupling a compressed air supply source to the opening.

6. The method of claim 5 wherein air pressure is supplied from a bottle of compressed gas.

7. The method of claim 6 wherein the gas was compressed from the earth's atmosphere and therefore comprises a mixture of gasses typical of air.

8. The method of claim 6 wherein the gas is predominantly a single gas.

9. A method for supplying anti-freeze into a sea water supply system in a boat, comprising:
a. having in a boat a sea water supply system comprising an inlet port, an inlet port valve, a water intake hose, a strainer having a normally closed opening, a component that requires sea water, and an exit port;
b. opening the strainer opening and coupling to the opening an anti-freeze supply means which supplies anti-freeze as needed for winterization of the system;
c. operating the component that requires sea water to draw anti-freeze into the component,
d. uncoupling from the opening the anti-freeze supply means, and
e. closing the opening.

10. The method of claim 9 wherein the opening supports a lid on top of the strainer.

11. The method of claim 10 wherein the anti-freeze supply means comprises a reservoir sitting on the strainer.

12. The method of claim 11 wherein the reservoir has a conical open bottom portion that couples to the strainer opening by protruding into the strainer opening.

13. The method of claim 12 wherein the reservoir has an upper opening for receiving anti-freeze that is wider than the conical open bottom portion.

14. The method of claim 12 wherein the reservoir is coupled to a spring that, when installed on the strainer, urges the conical open bottom portion into contact with the strainer.

15. The method of claim 14 wherein the spring comprises a bungee cord.

16. A system for winterizing a boat component supplied with a sea water system that supplies sea water to the boat component, comprising:
(a) an air-pressure-supply means that can be used to pressurize the system and thereby force water out an inlet port,
(b) an anti-freeze supply means that will supply anti-freeze liquid into the system when the component that is to be winterized is operated to draw water, and
(c) means for coupling the an air-pressure-supply means and the anti-freeze supply means to at least one opening in the sea water system that supplies sea water to the boat component.

17. The system of claim 16 wherein the air pressure supply means is a tube for use with an outlet of a vacuum cleaner.

18. The system of claim 16 wherein the air pressure supply means is a tube for coupling to an air compressor or bottle of compressed gas.

19. The system of claim 16 wherein the anti-freeze supply means is a funnel large enough to hold all the needed anti-freeze.

20. The system of claim 16 wherein the means for coupling the air-pressure-supply means and the anti-freeze supply means to at least one opening in the sea water system spring comprises a bungee cord used to couple the funnel to an opening of the water system.

21. The system of claim 16 wherein the funnel has female threads and the pressurized gas supply tube has male threads that allow them to be coupled together.
